(19) United States
(12) Patent Application Publication
(10) Pub. No.: US 2013/0177147 A1
(43) Pub. Date: Jul. 11, 2013

(54) SYSTEMS, METHODS AND COMPUTER READABLE MEDIA FOR DYNAMICALLY ASSIGNING CONTACTS TO AGENTS

(71) Applicants: Daniel Nuri Gocay, Livonia, MI (US); Eric Tanney, Virginia Beach, VA (US)

(72) Inventors: Daniel Nuri Gocay, Livonia, MI (US); Eric Tanney, Virginia Beach, VA (US)

(21) Appl. No.: 13/740,074

(22) Filed: Jan. 11, 2013

Related U.S. Application Data
(60) Provisional application No. 61/585,644, filed on Jan. 11, 2012.

(51) Int. Cl. H04M 3/523

(52) U.S. Cl. CPC H04M 3/5233
USPC 379/265.02

(57) ABSTRACT

Systems, methods and computer-readable media for dynamically assigning contacts to agents include calculating a unique contact proficiency score for at least a portion of a plurality of agents, the unique contact proficiency score corresponding to a unique contact type. By assigning contacts to agents based on unique contact proficiency score and availability, an embodiment can reduce or eliminate a need for static assignment of one or more call center agents to a specific type of contact.

This application claims the benefit of U.S. Provisional Application No. 61/585,644, filed on Jan. 11, 2012, entitled “Systems, Methods and Computer Readable Media for Dynamically Assigning Contacts to Agents”, which is incorporated herein by reference in its entirety.

Embodiments relate generally to assigning contacts to agents within a contact center, and, more particularly to systems, methods and computer-readable media for dynamically assigning contacts to agents based on a unique contact proficiency score, among other things.

In the context of a contact center (e.g., a call center), contacts (e.g., phone calls, video chats, e-mails, web chats, instant messages, text messages, social media interactions and the like) are generally delivered to contact center agents based on respective assigned roles (or skills) of the agents.

These skills are typically statically assigned to agents in an automatic call distributor (ACD). There are two methods traditionally used in contact centers for delivering contacts to agents: Longest Available Agent and Oldest Call/Contact Waiting. In Longest Available Agent (LAA), when a new contact is presented to the contact center, the agent in the skill corresponding to the contact that has been without a contact for the longest time will receive the contact. This assignment is done without any comparison of the agent's strengths. The deciding factor of which agent will receive the contact is based solely on static skill assignments and length of idle time. If there are no available agents, the contact can be placed into a queue.

Contacts are generally answered in the order received, so when an agent indicates readiness to take a new contact, the contact that has been waiting in the queue the longest for a particular agent's skill assignment can be routed to that agent.

One or more embodiments were conceived in light of the above-mentioned limitations or problems, among other things.

In an embodiment, an ACD may no longer need to use static skill assignments to deliver contacts to agents. In fact, no skill assignments may need to be configured on the ACD system.

An embodiment can include a database configured to store attributes possessed by an agent and a score representing that agent's proficiency in each respective attribute. Attributes can include, for example, selling a specific product, handling a particular type of transaction, speaking a certain language or the like. The database can also be configured to store other agent attributes, such as performance metrics (attendance, schedule adherence, sales percentages, handle time, information from third party data sources such as a customer relationship management (CRM) system, or the like).

The attributes corresponding to a unique contact type, along with an optional weight factor reflecting relative importance of an attribute for that contact type, can be user-assignable using a graphical user interface to associate attributes and weights with a specific contact type. Once a contact is presented to a contact center having an embodiment, a unique contact type can be determined. The unique contact type can be determined from basic contact information such as the channel from which the contact arrives at the contact center (such as email address, website link, or dialed telephone number) and/or responses the contact has made to an automated system such as an interactive voice response (IVR) system. Also, other contact attributes can be derived from information known about the customer (e.g., through a connection to a CRM application) and/or keywords in a written contact, and used to help identify a unique contact type for the contact. The contact information and/or attributes can also be passed to an external application embodiment.

Contacts can arrive at a contact center via one of several routes, including from an automated system, from the Internet or public network (such as a public switched telephone network (PSTN)), or by agent-initiated transfer (either internal or external).

Once a unique contact type has been determined, an embodiment can then retrieve the set of agent attributes that have been selected (and optionally weighted) for this type of contact.

An application embodiment can then query, by unique contact type and agent qualification, the configured and logged on agent population for a group of agents most qualified to handle that type of contact. The application can then search the logged on agent population for agents currently available to handle the contact immediately. If there is a single agent available to handle this contact, the application can instruct the ACD to present the contact to the agent. If there is more than one agent available to handle the contact, the application can select the agent having the highest unique contact proficiency score for the particular contact and instruct the ACD to deliver the contact to the agent. The unique contact proficiency score can be computed by taking a selected portion of the attributes of the unique contact type, retrieving an agent's scores or values for the selected attributes and applying any weighting of the attributes. Unique contact proficiency scores can be pre-computed and updated on a periodic basis (e.g., daily). Further, unique contact proficiency scores can include raw scores/values and/or normalized scores/values.

In the event agents are logged that are capable of handling the contact but none of these agents are available, the contact can be queued. While the contact is queued, the customer can be delivered queue treatment as per defined business rules (e.g., placed on hold and delivered on-hold music or message). When an agent indicates readiness to take another contact, the application can poll the agent's attributes against the contacts that are currently queued. The application can then select a contact type that corresponds with the best ability possessed by that agent and instruct the ACD to deliver the longest waiting contact in that contact type to the agent.

An embodiment can also include a graphical user interface, or GUI, that can allow the modification of attributes (or proficiencies), contact types, the makeup and weighting of proficiencies associated with specific contact types, and the management of contact types in relation to agents. The GUI can connect with a back-end database used by an application embodiment to allow real-time updates of the above-mentioned information.

### BRIEF DESCRIPTION OF THE DRAWINGS

FIGS. 1-3 show a chart of an exemplary method for assigning contacts to agents in accordance with at least one embodiment.

FIG. 4 is a chart of exemplary unique proficiency score elements in accordance with at least one embodiment.

FIG. 5 is a diagram of an exemplary single data center system for assigning contacts to agents in accordance with at least one embodiment.

FIG. 6 is a diagram of an exemplary redundant data center system for assigning contacts to agents in accordance with at least one embodiment.

FIG. 7 is a diagram of an exemplary cloud-based system for assigning contacts to agents in accordance with at least one embodiment.

FIG. 8 is a diagram of an exemplary application data flow for assigning contacts to agents in accordance with at least one embodiment.

### DETAILED DESCRIPTION

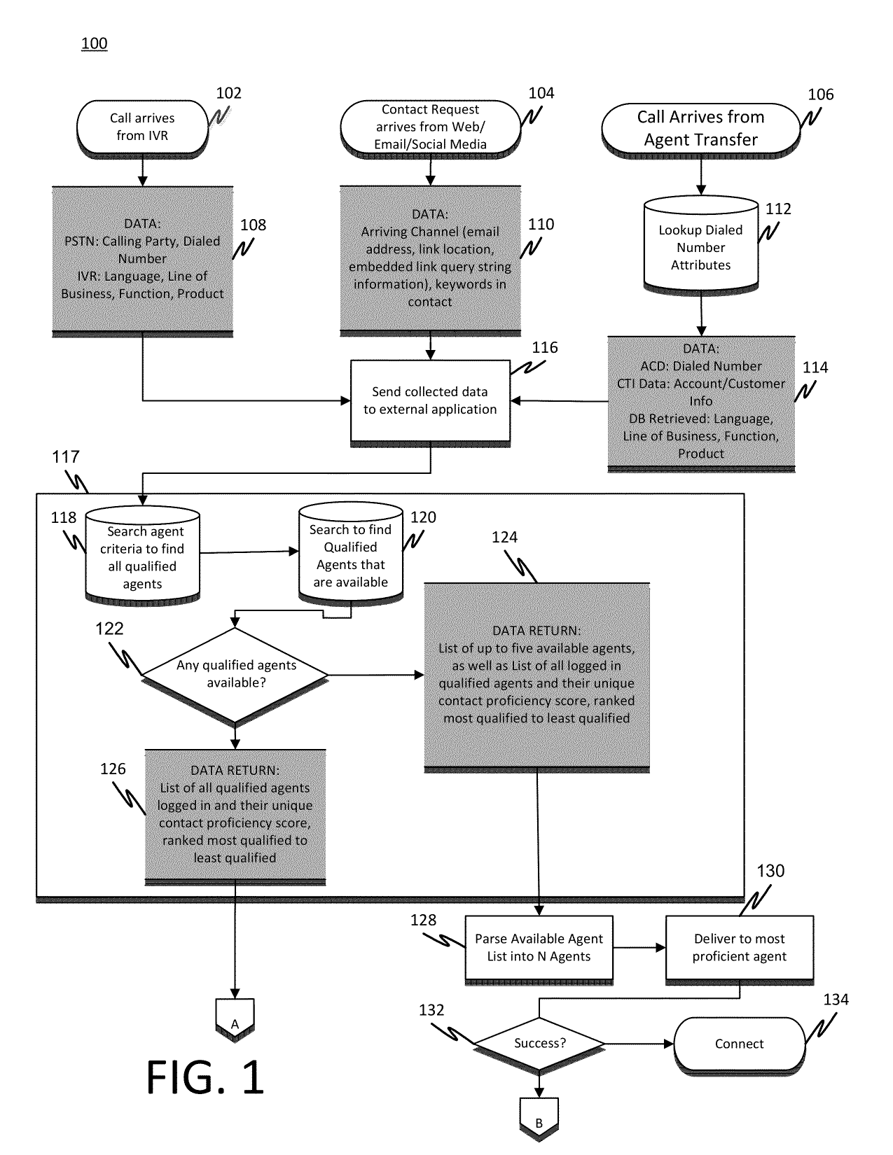

FIGS. 1-3 show a chart of an exemplary computerized method (or process) 100 for assigning contacts to agents. Processing may begin when a call arrives from an IVR 102, as an electronic message (e.g., email, Internet, web or social media) 104, or from an agent transfer 106.

At 108, data associated with the inbound telephone or IVR contact is collected. The data can include information from a PSTN, such as calling party, dialed number and the like. The data can also include information from the IVR system such as language, line of business, function, product or the like. Processing continues to 116.

At 110, data associated with an inbound electronic message contact is collected. The data can include arriving electronic message channel information (e.g., email address, link location, embedded link query string information, social media user name, mobile phone number, or the like). The data can also include information from a web contact such as keywords or a search query. Processing continues to 116.

At 112, attributes from a dialed number of a transfer call are looked up. Processing continues to 114.

At 114, data associated with the transfer call is collected. The data can include the dialed number from the ACD and/or computer telephony integration (CTI) data such as account number, customer information or the like. The data can also include information retrieved from a database such as language, line of business, function, product or the like. Processing continues to 116.

At 116, the collected data is sent to an external application embodiment of the UCPS system (117). For example, the UCPS application server can collect the contact data sent from the various systems. In a Cisco-based embodiment (see detailed discussion below), contact data can be sent via the ICM to the CVP and to the UCPS application server webservice. Processing continues to 118.

At 118, agent attribute values are searched (e.g., from the data stored in the UCPS ADB) to find and generate a list of all qualified agents. A qualified agent can include an agent having a UCPS for the unique contact type of the contact. Processing continues to 120.

At 120, the list of qualified agents is searched to determine which of the qualified agents are available (e.g., logged in). For example, the ADB can interface with the contact center routing/ACD system (or in a Cisco-based embodiment, the ADB can interface with ICM's backend databases). Processing continues to 122.

At 122, a determination is made regarding whether any qualified agents are available. If so, processing continues to 124. If not, processing continues to 126.

At 124, the system (e.g., in a Cisco-based embodiment, the UCPS application server passes the data to CVP, which in turn provides the data to ICM) generates (or returns) a list having a predetermined number (e.g., five) of available agents along with a list of all logged in qualified agents and their respective unique contact proficiency scores, the list being ranked from most qualified to least qualified based on UCPS. Processing continues to 128.

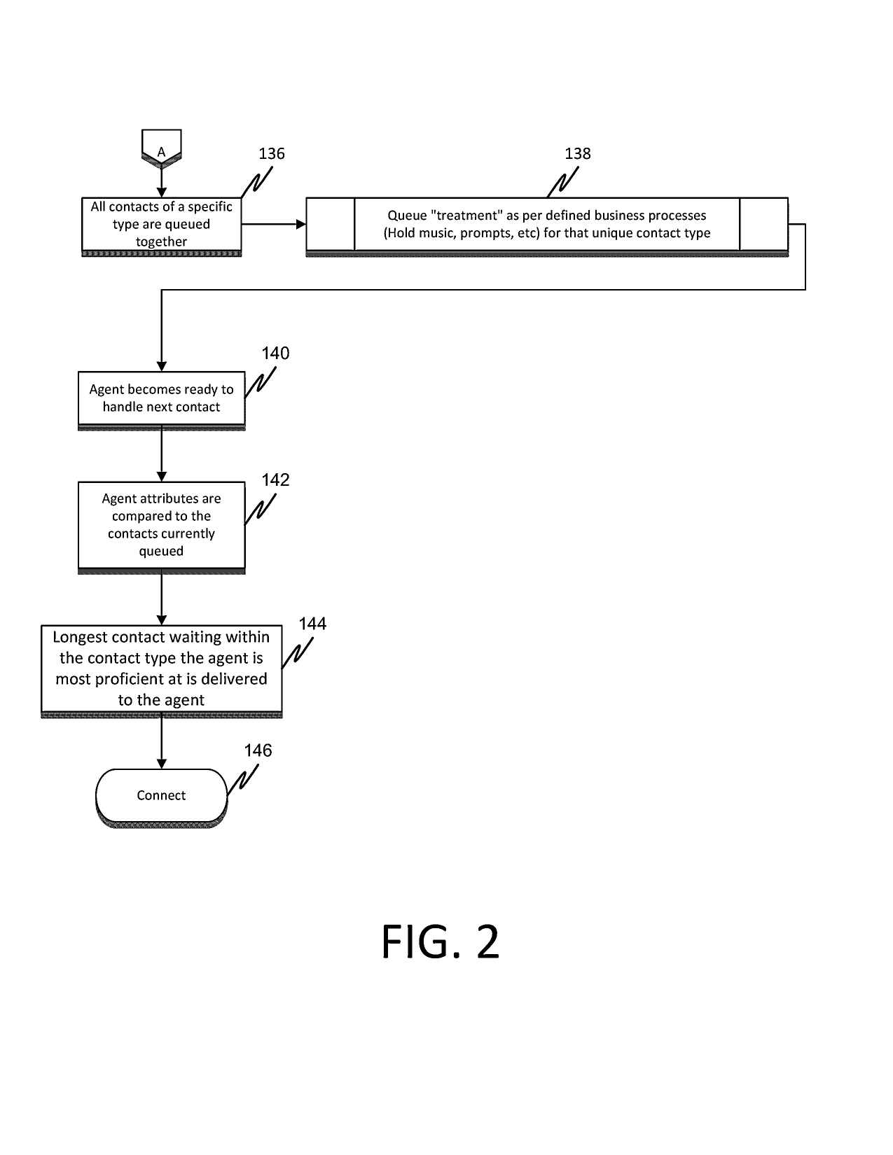

At 126, a list of all qualified agents logged in and their respective unique contact proficiency scores is returned (e.g., in a Cisco-based embodiment, from the UCPS application server to CVP and on to ICM), with the list being ranked from most qualified to least qualified. Processing continues to 136 (see sheet connector A in FIG. 2).

At 128, the available agent list is parsed into a list having N agents (e.g., N=5). Processing continues to 130.

At 130, the system attempts to assign and deliver the contact to the first agent in the list of N agents. Processing continues to 132.

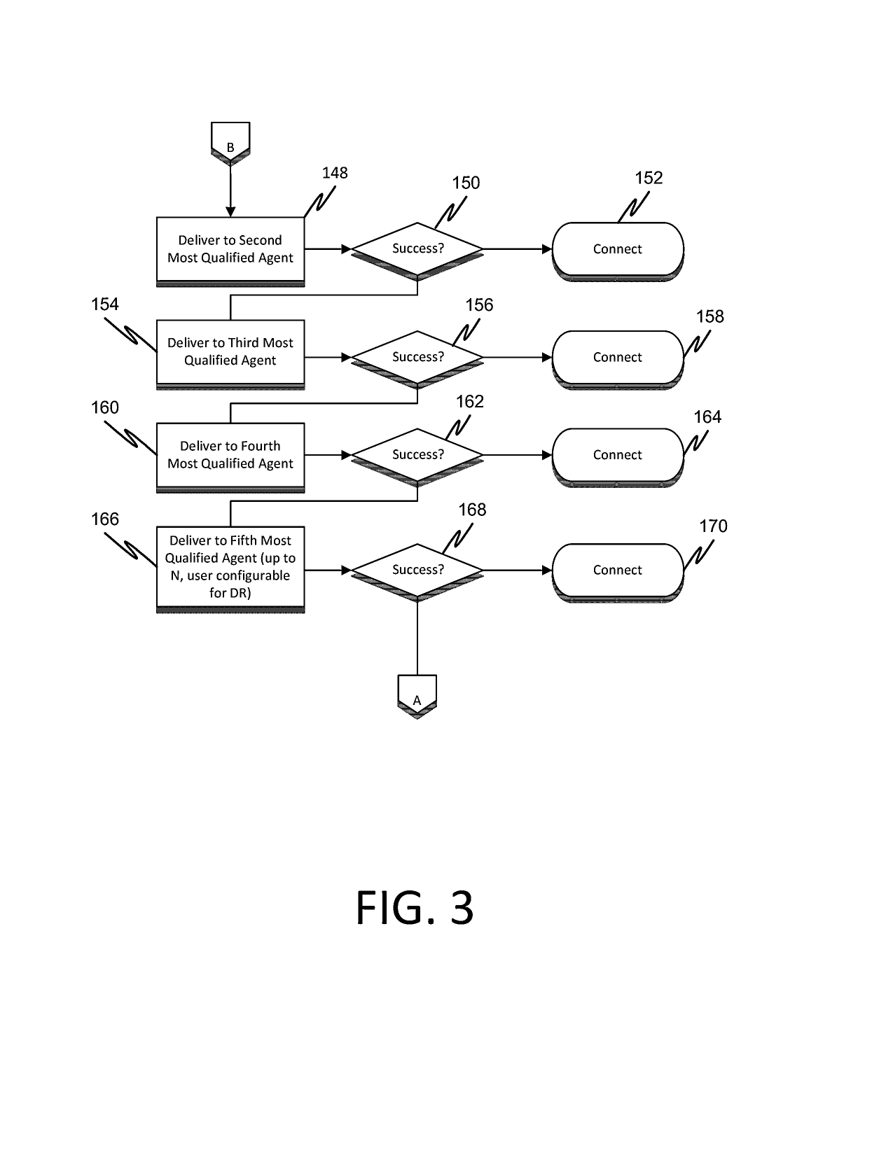

At 132, it is determined whether the attempt to assign and deliver was successful. If so, processing continues to 134, where the contact and the agent are connected. If not, processing continues to 148 (see sheet connector B in FIG. 3).

At 136, all contacts of a specific type are queued together. Processing continues to 138.

At 138, queued contacts are provided with queue “treatment” as defined by business processes (e.g., on hold music, informational messages, prompts or the like) for that unique contact type. Processing continues to 140.

At 140, an indication is received that an agent has become ready to take a next contact. Processing continues to 142.

At 142, attributes of the agent that became ready are compared to the contacts currently queued. Processing continues to 144.

At 144, the longest waiting contact within the contact type that the agent is most proficient at is assigned/delivered to the agent. Processing continues to 146, where the contact and the agent are connected.

At 148, an attempt is made to assign/deliver the contact to the second most qualified agent in the list of N agents. Processing continues to 150.

At 150, it is determined whether the attempt was successful. If so, processing continues to 152 where the contact and agent are connected. If not, processing continues to 154.

At 154, an attempt is made to assign/deliver the contact to the third most qualified agent in the list of N agents. Processing continues to 156.

At 156, it is determined whether the attempt was successful. If so, processing continues to 158 where the contact and agent are connected. If not, processing continues to 160.

At 160, an attempt is made to assign/deliver the contact to the fourth most qualified agent in the list of N agents. Processing continues to 162.

At 162, it is determined whether the attempt was successful. If so, processing continues to 164 where the contact and agent are connected. If not, processing continues to 166.

At 166, an attempt is made to assign/deliver the contact to the fifth most qualified agent in the list of N agents. Processing continues to 168.

At 168, it is determined whether the attempt was successful. If so, processing continues to 170 where the contact and agent are connected. If not, processing continues to 136 (see sheet connector A in FIG. 2).

It will be appreciated that the specific numbers described above (e.g., N=5) are for illustration purposes and numbers of a lesser or greater value can be used. Also, it will be appreciated that the above-mentioned steps can be repeated in whole or in part in order to accomplish a contemplated contact assignment/delivery task.

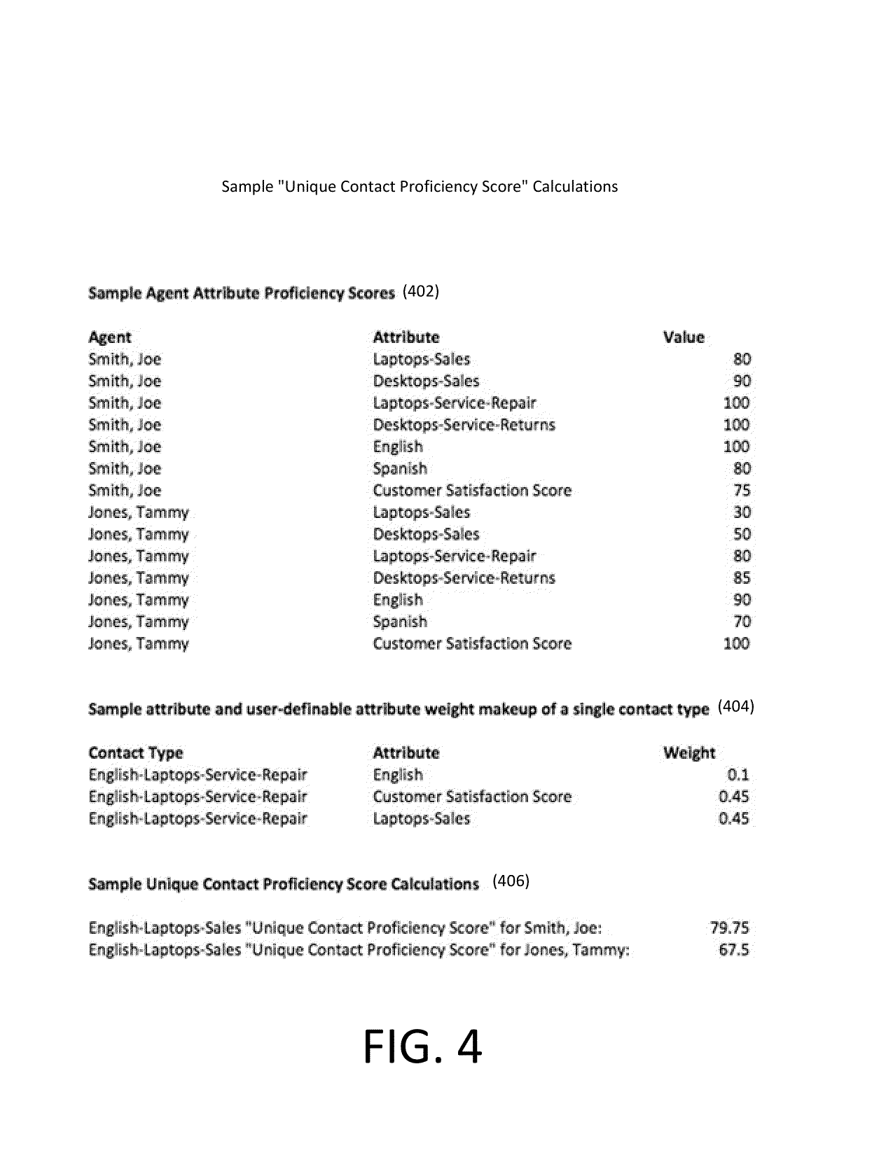

FIG. 4 is a chart showing exemplary unique proficiency score data items. As shown in FIG. 4, the UCPS data items can include agent attribute proficiency score records 402 that can include fields such as an agent identifier (e.g., name, agent number, employee number or the like), an attribute identifier (e.g., a label, attribute identification number or the like), and a value (e.g., a numerical score representing an attribute proficiency of a particular agent).

The UCPS data items can also have unique contact type attribute weight records (404) that can include fields such as a contact type identifier, an attribute identifier and a weight value.

Further, the UCPS data items can include unique contact proficiency score calculation records 406 that can have fields such as a unique contact type identifier, an agent identifier and a UCPS value.

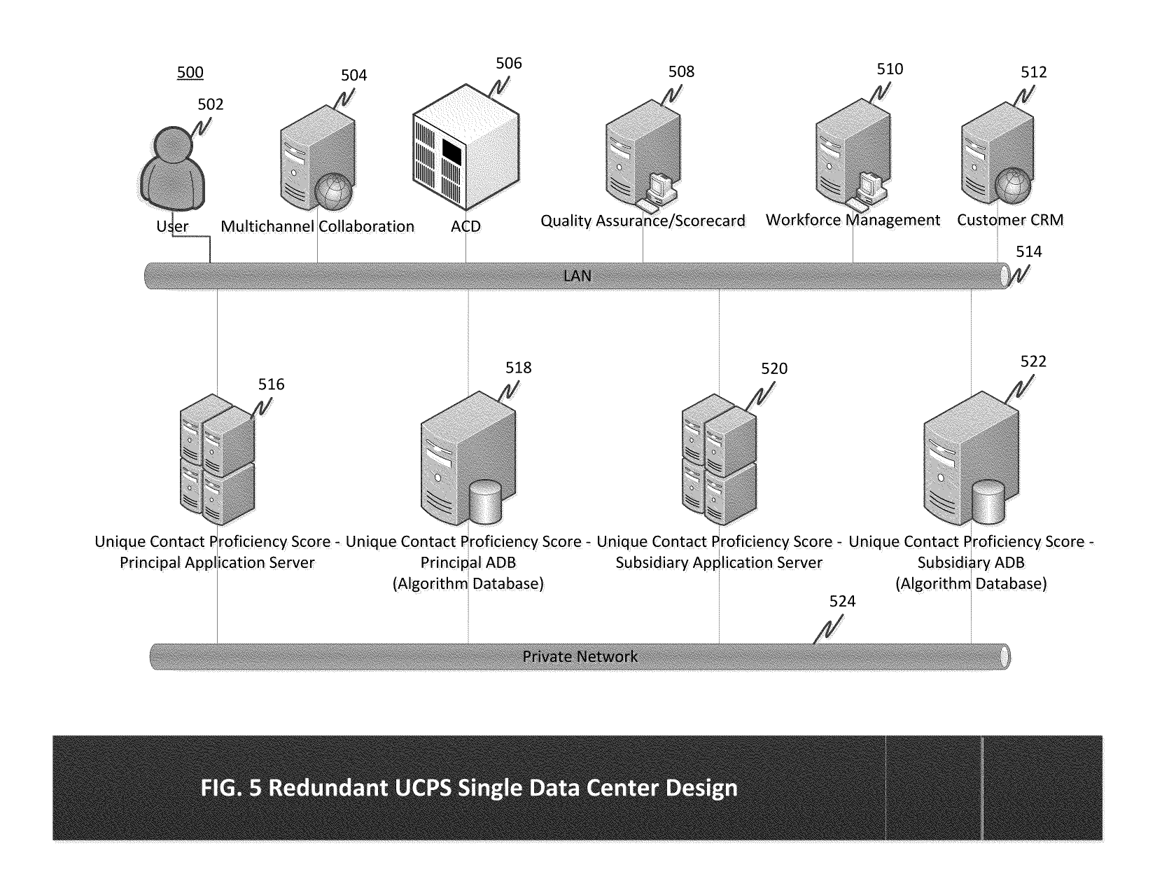

FIG. 5 is a diagram of an exemplary single data center system 500 for assigning contacts to agents. The system includes traditional contact center components such as a multichannel collaboration system 504, an ACD 506, a quality assurance/scorecard system 508, a workforce management system 510 and a CRM system 512 all coupled to a LAN 514. Also coupled to the LAN 514 are a UCPS principal application server 516, a UCPS principal application database (ADB) 518, a UCPS subsidiary application server 520 and a UCPS subsidiary ADB 522, which are also coupled to a private network 524.

In operation, contacts arrive through one of several channels and are brought into the contact center via the multichannel collaboration system 504. Contacts can arrive via one of the channels mentioned above. Also, contact can arrive via a mobile device after scanning a bar code (e.g., QR code or the like) or after sending an SMS text message to a specific phone number (or shortcode number). Further, a “call” button can be placed on a website or in a mobile device application (e.g., iPhone or Droid app, or the like) that, when pressed, will connect a person with a contact center having an embodiment. The application or QR code processing software can instruct a mobile phone to dial a number (e.g., a toll free number). From that point, the contact may be presented in a manner similar to a traditional inbound phone call delivered, for example via the PSTN. Information about the contact is sent to the UCPS principal application server 516, which determines the unique contact type of the contact.

Using the unique contact type, the UCPS principal application server 516 can issue one or more queries to the principal ADB server 518 requesting information regarding the agents most qualified to handle the contact. The UCPS principal application server 516 can also use information from other systems, such as the workforce management system 510, to determine which, if any, of the qualified agents are available.

The UCPS principal application server 516 can then communicate with the ACD 506 in order to attempt to assign/deliver the contact to a particular agent.

The UCPS principal application server 516 in connection with the principal ADB server 518, and with information from other systems, can assign contacts to agents in accordance with the method described above with respect to FIGS. 1-3. The UCPS subsidiary application server 520 and the UCPS subsidiary ADB 522 can provide disaster recovery and/or load balancing functions. It may be important for an embodiment to be highly fault tolerant.

In general, the UCPS principal application server 516 runs a web service that brokers communications between other systems and the principal ADB server 518.

Information from other systems can be consumed by the UCPS application server/ADB for purposes of updating UCPS values for agents. For example, quality management information from the quality assurance/scorecard system 508 can be used to determine agent proficiencies for a particular attribute.

Also, the UCPS principal application server 516 can run a GUI that will permit a user to associate agent/contact attributes with a unique contact type and to also optionally assign a weight value to one or more of the attributes. The GUI can be viewed and used on a variety of end user devices such as a wireless phone (e.g., an Apple iPhone, a feature phone, a smart phone or the like), a personal digital assistant (e.g., a Blackberry, a Palm OS device, a Windows Mobile device or the like), a portable computer (e.g., a laptop, netbook, notepad computer, tablet computer, Apple iPad, palm top computer or the like), an ebook reader (e.g., Amazon Kindle, Barnes and Noble Nook, Sony ebook reader or the like), a portable media player (e.g., Apple iTouch or the like), a desktop computer (e.g., a PC-compatible, an Apple Macintosh, or the like) or other suitable computing device. In general, any computing device capable of being programmed to perform the functions in accordance with the present disclosure and as described herein can be used.

Further, when being accessing by users (e.g., agents, managers, supervisors or the like) the UCPS system can be configured to integrate the existing user lists/roles stored in existing ACDs (e.g., the ACDs (or equivalents) made by Cisco, Avaya, Aspect and others).

The UCPS system can read the database and grant access at that level. If those levels do not exist in the ACD, the UCPS system can support these levels independently.

The UCPS system can also be configured to integrate with active directory users and groups for authentication and permissions.

For example, a user can sign into an SSL web interface (e.g., via https) to the UCPS principal admin server. If the principal server is down there can be a 404 redirect to an auxiliary (or subsidiary) admin server.

The UCPS principal application server can validate the credentials against an access list. The levels of access can include, for example:

User—agent level access to view same agent proficiencies;

Supervisor—having access to control attributes/proficiencies of agents assigned to supervisor;

Manager—system level access to control attributes/proficiencies of all defined agents as well as the Unique Contact types (and the n dimensions thereof created by the combination of proficiencies and weights);

System Manager—all access to the above functions and also including debugging tools, tracers, and database connections

Once logged in and validated, a user can make updates via a GUI (as discussed above) and the UCPS principal application server can validate the changes and update the UCPS principal ADB.

A GUI embodiment can include functions that permit a supervisor to set proficiencies by dragging and dropping to create a contact type. Then, the user can adjust the proficiency makeup with a slide bar (or by directly entering percentage) to make up the total proficiency (e.g., 100% required in the type).

Also, a GUI embodiment can include interface elements that permit a supervisor user to assign proficiencies by dragging and dropping them to the agent (or by selecting them from a drop down list, or the like). It will be appreciated that any suitable interface elements can be used.

The server computers mentioned herein can include a single server computer, a distributed server computer, a cloud computing system or any computing system suitable for performing server functions. In general, any computing device capable of being programmed to perform server function in accordance with the present disclosure can be used.

Each nontransitory computer readable medium mentioned can include RAM, ROM, EEPROM, flash memory, CD, DVD, magnetic disc drive, optical disc drive, electronic memory and/or any now known or later developed computer readable medium suitable for storing instructions and/or data.

Each processor can include a microprocessor, microcontroller, digital signal processor, application specific integrated circuit, programmable logic device and/or the like.

The networks and link(s) mentioned herein can each include one or more of a local area network, a wide area network, the Internet, a virtual private network, a wireless network (WiFi, cellular, Bluetooth or the like), a wired network or the like.

An embodiment can include off-the-shelf hardware and/or software components that have been configured or tailored via software instructions to perform functions in accordance with the present disclosure. For example, an embodiment can be based on hardware and/or software components manufactured by Cisco Systems, Inc. of San Jose, Calif.

In a Cisco-based embodiment, the ACD is called a UCM (or Unified Communications Manager). Cisco makes a routing engine called ICM, or Intelligent Contact Management. Cisco's IVR/VXML platform is called CVP, or Cisco Voice Portal. Calls ingress via a Cisco Router running a version of IOS (Cisco's Router Operating System, not to be confused with the Apple iPhone operating system) and the contact is passed through CVP to ICM. ICM then executes a script that is responsible for handing treatment instructions to CVP, to query various skill groups, see which agents are logged on and check hours of operation, etc. ICM scripts are where business logic is coded for contact centers. To integrate with an embodiment of our invention, the ICM script will direct CVP to execute a VXML application.

That VXML application will query a webservice on the UCPS application server. The UCPS application server will then reach out to the UCPS ADB server, which will query the internal UCPS data and the ICM Data. The ICM Data informs the system as to the state of the agents for delivering a contact to (if they're on a call, ready to take a call, at lunch, etc.). Once the agent list has been generated, the UCPS system will respond to the request (via the webservice call) and send the response to CVP.

CVP will hand the list back to ICM, which will parse it out, and issue a LABEL (that's the end result of an ICM script) containing the Agent's ID. This will cause the contact to be assigned/routed to the agent.

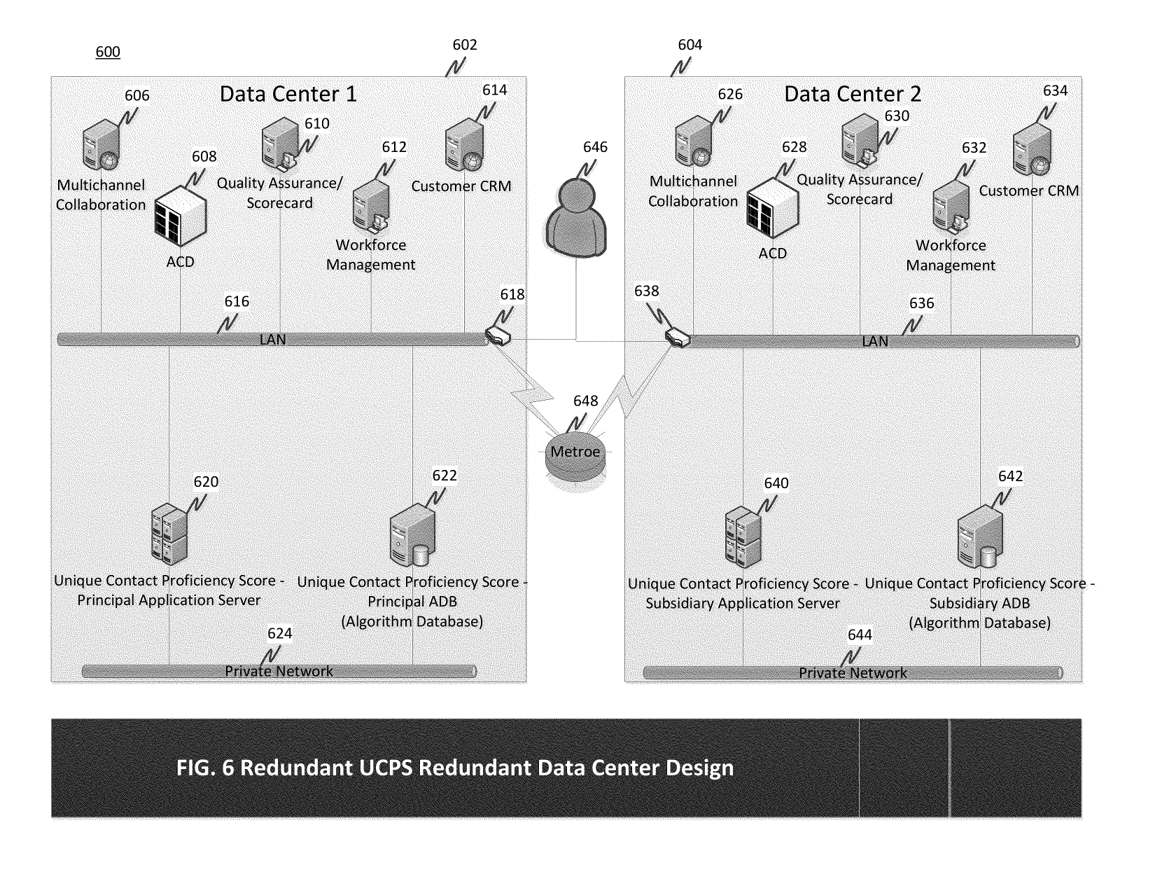

FIG. 6 is a diagram of an exemplary redundant data center system 600. The system includes a first data center 602 and a second data center 604.

Each of the data centers (602 and 604) includes, respectively, a multichannel collaboration system (606, 626), an ACD (608, 628), a quality assurance/scorecard system (610, 630), a workforce management system (612, 632) and a CRM system (614, 634) all coupled to a LAN (616, 636) that is coupled via a router (618, 638) to a network 648. Also coupled to the LAN (616, 636) are a UCPS principal application server (620, 640), a UCPS principal application database (ADB) (622, 642), which are also coupled to a private network (624, 644).

The data centers (602 and 604) can assign contacts to agents according to the method described above with respect to FIGS. 1-3.

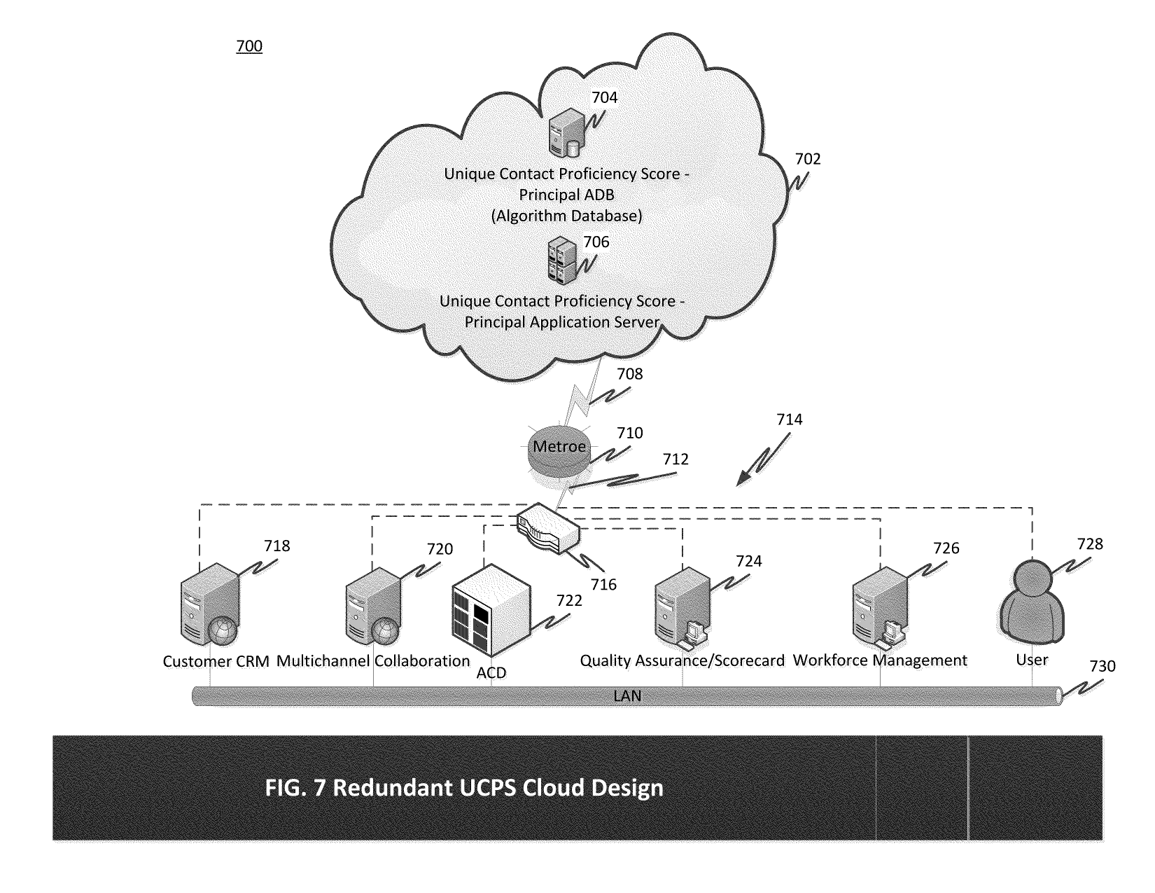

FIG. 7 is a diagram of an exemplary cloud-based system 700 for assigning contacts to agents. The system 700 includes a cloud computing system 702 running an instance of the UCPS principal ADB 704 and UCPS principal application server 706. The cloud computing system 702 is coupled by a link 708 to a MetroE (or metro Ethernet) data communications path 710, which is in turn coupled to a link 712 and router 716. The router 716 is coupled to a local network 714. The system 700 also includes a CRM system 718, a multichannel collaboration system 720, an ACD 722, a quality assurance/scorecard system 724, a workforce management system 726, all coupled to a LAN 730. The cloud-based system 700 can assign contacts to agents in accordance with the method described above with respect to FIGS. 1-3.

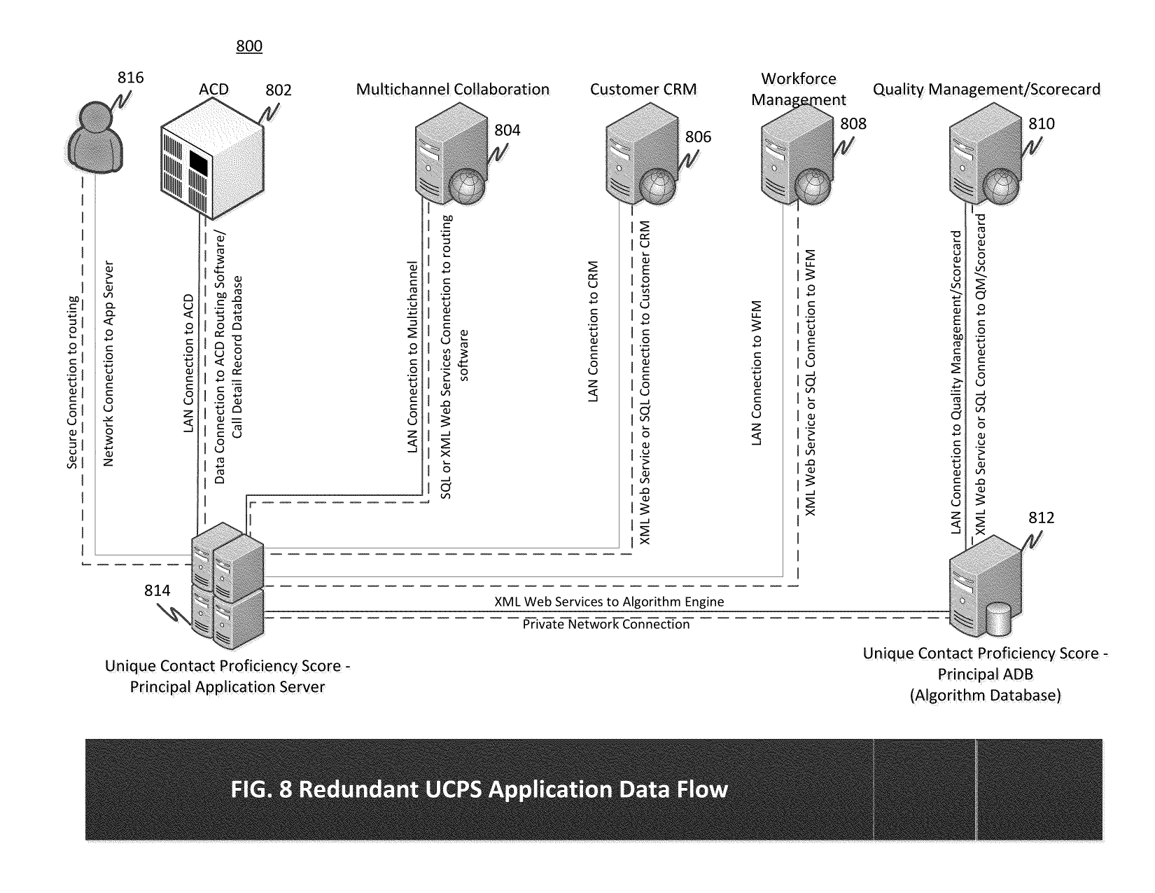

FIG. 8 is a diagram of an exemplary application data flow 800 for assigning contacts to agents. An ACD 802 is connected to a UCPS application server 814 via a LAN connection so that the ACD 802 routing software and call detail database are accessible to the UCPS application server 814. A multichannel collaboration system 804 is coupled to the UCPS application server 814 via a LAN connection in order to provide an SQL or XML web services connection to routing software.

A customer CRM system 806 is coupled to the UCPS application server 814 via a LAN connection that supports an XML web service or SQL connection between the UCPS application server and the CRM system 806.

A workforce management system 808 is coupled via a LAN connection to the UCPS application server to provide an XML web service or SQL connection between the UCPS application server and the workforce management system 808.

A quality management/scorecard system 810 is coupled via a LAN connection to the UCPS ADB 812 in order to provide an XML web service or SQL connection between the quality management system 810 and the ADB 812.

The UCPS application server 814 is coupled to the UCPS ADB 812 via a private network connection that provides a communication path for XML web services to the algorithm engine. While connections in FIG. 8 are described above as LAN connections for illustration purposes, it will be appreciated that any suitable wired or wireless network connections could be used.

The users shown in FIGS. 5-8 (502, 646, 728 and 816, respectively) can be an agent, manager, supervisor or the like. In general, any user of the system can be represented by the user symbols in FIGS. 5-8, although the different types of users may have different levels of access within the UCPS system, as discussed above.

It will be appreciated that the various network types described above are for illustration purposes. Other suitable network types can be used. For example, MetroE is mentioned in connection with various embodiments, however any larger, low-latency, fault tolerant data circuit could be used in place of MetroE. In general, any now known or later developed wired or wireless data network could be used with an embodiment.

It will be appreciated that the modules, processes, systems, and sections described above can be implemented in hardware, hardware programmed by software, software instructions stored on a nontransitory computer readable medium or a combination of the above. A system for assigning contacts to agents can be implemented, for example, using a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C++, C#.net, Ruby or the like, and/or a scripting language such as javascript, PHP or the like. The instructions can also comprise code and data objects provided in accordance with, for example, the Visual Basic™ language, or another structured or object-oriented programming language. The sequence of programmed instructions and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core). Also, the processes, system components, modules, and sub-modules described in the various figures of and for embodiments above may be distributed across multiple computers or systems or may be co-located in a single processor or system. Exemplary structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer readable media may be readily implemented, fully or partially, in software using, for example, object or object-oriented software development environments that provide portable source code that can be used on a variety of computer platforms. Also, proprietary or specific-purpose scripting and/or programming languages may be used for various components mentioned above.

For example, the Cisco ICM is programmed in an ICM Scripting specific to the ICM. CVP is VXML (Voice Extensible Markup Language), and can have some Java in it. The webservice can be written in .NET. The handler on the ADB can be written in .NET. The database itself can be Microsoft SQL (or another database management system such as Oracle or the like). The user interface can be written in .NET.

Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the user interface, web, contact center and/or computer programming arts.

It is, therefore, apparent that there is provided, in accordance with the various embodiments disclosed herein, systems, methods and computer-readable media for assigning contacts to agents.

While the invention has been described in conjunction with a number of embodiments, it is evident that many alternatives, modifications and variations would be or are apparent to those of ordinary skill in the applicable arts. Accordingly, Applicants intend to embrace all such alternatives, modifications, equivalents and variations that are within the spirit and scope of the invention.

What is claimed is:

1. A system for dynamically assigning contacts to agents, the system comprising:
any feature described, either individually or in combination with any feature, in any configuration.

2. A method of dynamically assigning contacts to agents, the method comprising:
one or more steps of any process described, in any order, using any modality described.

3. A nontransitory computer readable medium having stored thereon software instructions that, when executed by a processor, cause the processor to perform a series of steps comprising:
one or more steps of any process described, in any order, using any modality described.
